(19) United States
(12) Patent Application Publication
(10) Pub. No.: US 2012/0243923 A1
(43) Pub. Date: Sep. 27, 2012

(54) IMAGE FORMING APPARATUS AND FIXING DEVICE

(75) Inventors: Yasuhiro UEHARA, Ebina-shi (JP); Kazuyoshi ITOH, Ebina-shi (JP)

(73) Assignee: FUJI XEROX CO., LTD., Tokyo (JP)

(21) Appl. No.: 13/348,346

(22) Filed: Jan. 11, 2012

(30) Foreign Application Priority Data
Mar. 25, 2011 (JP) 2011-067472

(51) Int. Cl. G03G 15/20

(52) U.S. Cl. 399/329

(57) ABSTRACT

An image forming apparatus includes: a toner image forming unit; a transfer unit transferring a toner image onto a recording medium; and a fixing unit. The fixing unit includes: a fixing member fixing toner onto a recording medium with a conductive layer heated by electromagnetic induction; a pressure member coming into pressure contact with an outer peripheral surface of the fixing member, forming a fixing pressure portion between the pressure member and the fixing member; a magnetic field generating member generating an alternate-current magnetic field intersecting with the conductive layer; and a heat storage member contacting the fixing member and facing the magnetic field generating member with the fixing member interposed therebetween, the heat storage member generating heat to supply heat to the fixing member. The image forming apparatus further includes first and second power supplies respectively supplying power to the magnetic field generating member and the heat storage member.

### CROSS REFERENCE TO RELATED APPLICATIONS

This application is based on and claims priority under 35 USC §119 from Japanese Patent Application No. 2011-67472 filed Mar. 25, 2011.

### BACKGROUND

1. Technical Field

The present invention relates to an image forming apparatus and a fixing device.

2. Related Art

In an image forming apparatus, such as a copier and a printer, using an electrophotographic method, a photoconductor formed into a drum shape, for example, is uniformly charged, and the photoconductor is exposed with light that is controlled on the basis of image information, to form an electrostatic latent image on the photoconductor. Then, the electrostatic latent image is turned into a visible image (a toner image) with toner, and the toner image is further transferred onto a recording medium, which is then fixed by a fixing device to perform image formation. For such a fixing device, there is known a fixing device using an electromagnetic induction heating method.

### SUMMARY

According to an aspect of the present invention, there is provided an image forming apparatus including: a toner image forming unit that forms a toner image; a transfer unit that transfers the toner image onto a recording medium; and a fixing unit. The fixing unit includes: a fixing member having a conductive layer, the fixing member fixing toner onto a recording medium with the conductive layer heated by electromagnetic induction; a pressure member that comes into pressure contact with an outer peripheral surface of the fixing member, thereby to form a fixing pressure portion between the pressure member and the fixing member, the fixing pressure portion allowing a recording medium carrying an unfixed image to pass therethrough; a magnetic field generating member that generates an alternate-current magnetic field intersecting with the conductive layer of the fixing member; and a heat storage member that is arranged so as to face the magnetic field generating member with the fixing member interposed therebetween while being arranged so as to be in contact with the fixing member, the heat storage member generating heat to supply heat to the fixing member. The image forming apparatus further includes: a first power supply that supplies electric power to the magnetic field generating member of the fixing unit; and a second power supply storing electric power, the second power supply electrically discharging to supply electric power to the heat storage member of the fixing unit.

### BRIEF DESCRIPTION OF THE DRAWINGS

Exemplary embodiment(s) of the present invention will be described in detail based on the following figures, wherein:

FIG. 1 is a diagram showing a configuration example of an image forming apparatus to which a fixing device of the exemplary embodiment is applied;

FIG. 2 is a front view showing a configuration of the fixing unit of the exemplary embodiment;

FIG. 3 is a cross-sectional view of the fixing device, taken along the line III-III in FIG. 2;

FIGS. 4A and 4B are configuration diagrams showing cross-sectional layers of the fixing belt;

FIG. 5 is a diagram illustrating the state in which the pressure roll is separated from the fixing belt by the moving mechanism;

FIG. 6 is a cross-sectional view illustrating a configuration of the IH heater of the exemplary embodiment;

FIG. 7 is a perspective view illustrating a configuration of the heat storage member of the exemplary embodiment; and

FIG. 8 is a diagram illustrating the resistive heating layer and the insulating layer in more detail.

### DETAILED DESCRIPTION

An exemplary embodiment of the present invention will be described below in detail with reference to the accompanying drawings.

### <Description of Image Forming Apparatus>

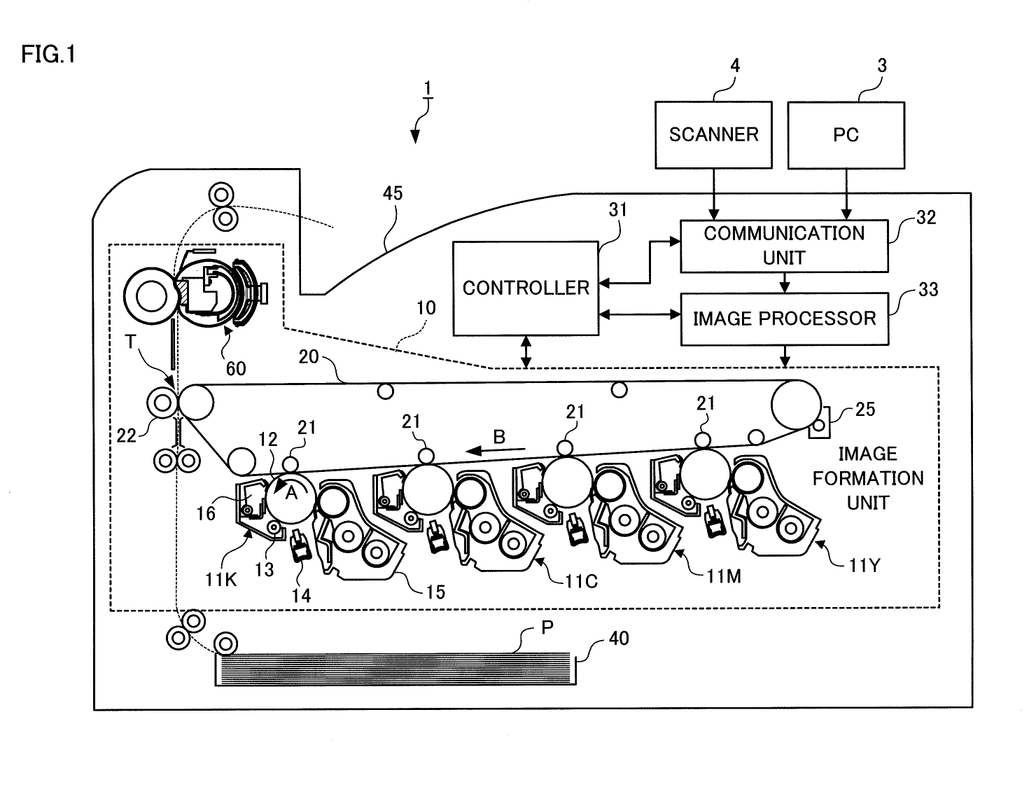

FIG. 1 is a diagram showing a configuration example of an image forming apparatus to which a fixing device of the present exemplary embodiment is applied. An image forming apparatus 1 shown in FIG. 1 is a so-called tandem-type color printer, and includes: an image formation unit 10 that performs image formation on the basis of image data; and a controller 31 that controls operations of the entire image forming apparatus 1. The image forming apparatus 1 further includes: a communication unit 32 that communicates with, for example, a personal computer (PC) 3, an image reading apparatus (scanner) 4 or the like to receive image data; and an image processor 33 that performs predetermined image processing on image data received by the communication unit 32.

The image formation unit 10 includes four image forming units 11Y, 11M, 11C and 11K (also collectively referred to as “image forming units 11”), which are examples of a toner image forming unit forming a toner image and are arranged side by side at predetermined intervals. Each of the image forming units 11 includes: a photoconductive drum 12 as an example of an image carrier that forms an electrostatic latent image and holds a toner image; a charging device 13 that uniformly charges the surface of the photoconductive drum 12 at a predetermined potential; a light emitting diode (LED) print head 14 that exposes, on the basis of color image data, the photoconductive drum 12 charged by the charging device 13; a developing device 15 that develops the electrostatic latent image formed on the photoconductive drum 12; and a drum cleaner 16 that cleans the surface of the photoconductive drum 12 after transfer.

The image forming units 11 have almost the same configuration except toner contained in the respective developing devices 15, and form yellow (Y), magenta (M), cyan (C) and black (K) toner images, respectively.

Further, the image formation unit 10 includes: an intermediate transfer belt 20 onto which multiple layers of color toner images respectively formed on the photoconductive drums 12 of the image forming units 11 are transferred; and primary transfer rolls 21 that sequentially transfer (primarily transfer) color toner images formed in the respective image forming units 11 onto the intermediate transfer belt 20. Furthermore, the image formation unit 10 includes: a secondary transfer roll 22 that collectively transfers (secondarily transfers) the color toner images superimposingly transferred onto the intermediate transfer belt 20, onto a sheet P which is a recording medium (recording sheet); and a fixing unit 60 as an example of a fixing unit (a fixing device) that fixes the color toner images having been secondarily transferred, onto the sheet P. Note that, in the image forming apparatus 1 according to the present exemplary embodiment, the intermediate transfer belt 20, the primary transfer rolls 21 and the secondary transfer roll 22 configure a transfer unit transferring a toner image onto a sheet P.

In the image forming apparatus 1 of the present exemplary embodiment, image formation processing using the following processes is performed under operations controlled by the controller 31. Specifically, image data from the PC 3 or the scanner 4 is received by the communication unit 32, and after the image data is subjected to certain image processing performed by the image processor 33, the image data of each color is generated and sent to a corresponding one of the image forming units 11. Then, in the image forming unit 11K that forms a black-color (K) toner image, for example, the photoconductive drum 12 is uniformly charged by the charging device 13 at the predetermined potential while rotating in the direction of an arrow A, and then is scanned and exposed by the LED print head 14 on the basis of the K color image data transmitted from the image processor 33. Thereby, an electrostatic latent image for the K-color image is formed on the photoconductive drum 12. The K-color electrostatic latent image formed on the photoconductive drum 12 is then developed by the developing device 15. Then, the K-color toner image is formed on the photoconductive drum 12. In the same manner, yellow (Y), magenta (M) and cyan (C) color toner images are formed in the image forming units 11Y, 11M and 11C, respectively.

The color toner images formed on the respective photoconductive drums 12 in the image forming units 11 are electrostatically transferred (primarily transferred) in sequence by the primary transfer rolls 21 onto the intermediate transfer belt 20 that moves in the direction of an arrow B. Then, superimposed toner images on which the color toner images are superimposed on one another are formed. Then, the superimposed toner images on the intermediate transfer belt 20 are transported to a region (secondary transfer portion T) at which the secondary transfer roll 22 is arranged, along with the movement of the intermediate transfer belt 20. A sheet P is supplied from a sheet holding unit 40 to the secondary transfer portion T at timing when the superimposed toner images being transported arrive at the secondary transfer portion T. Then, the superimposed toner images are collectively and electrostatically transferred (secondarily transferred) onto the transported sheet P by action of a transfer electric field formed at the secondary transfer portion T by the secondary transfer roll 22.

Thereafter, the sheet P onto which the superimposed toner images are electrostatically transferred is transported toward the fixing unit 60. The toner images on the sheet P transported to the fixing unit 60 are heated and pressurized by the fixing unit 60 and thereby are fixed onto the sheet P. Then, the sheet P having the fixed images formed thereon is transported to a sheet stack unit 45 provided at an output portion of the image forming apparatus 1.

Meanwhile, the toner (primary-transfer residual toner) remaining on the photoconductive drums 12 after the primary transfer and the toner (secondary-transfer residual toner) remaining on the intermediate transfer belt 20 after the secondary transfer are removed by the drum cleaners 16 and a belt cleaner 25, respectively.

In this way, the image formation processing in the image forming apparatus 1 is repeatedly performed for a designated number of print sheets.

### <Description of Configuration of Fixing Unit>

Next, a description will be given of the fixing unit 60 in the present exemplary embodiment.

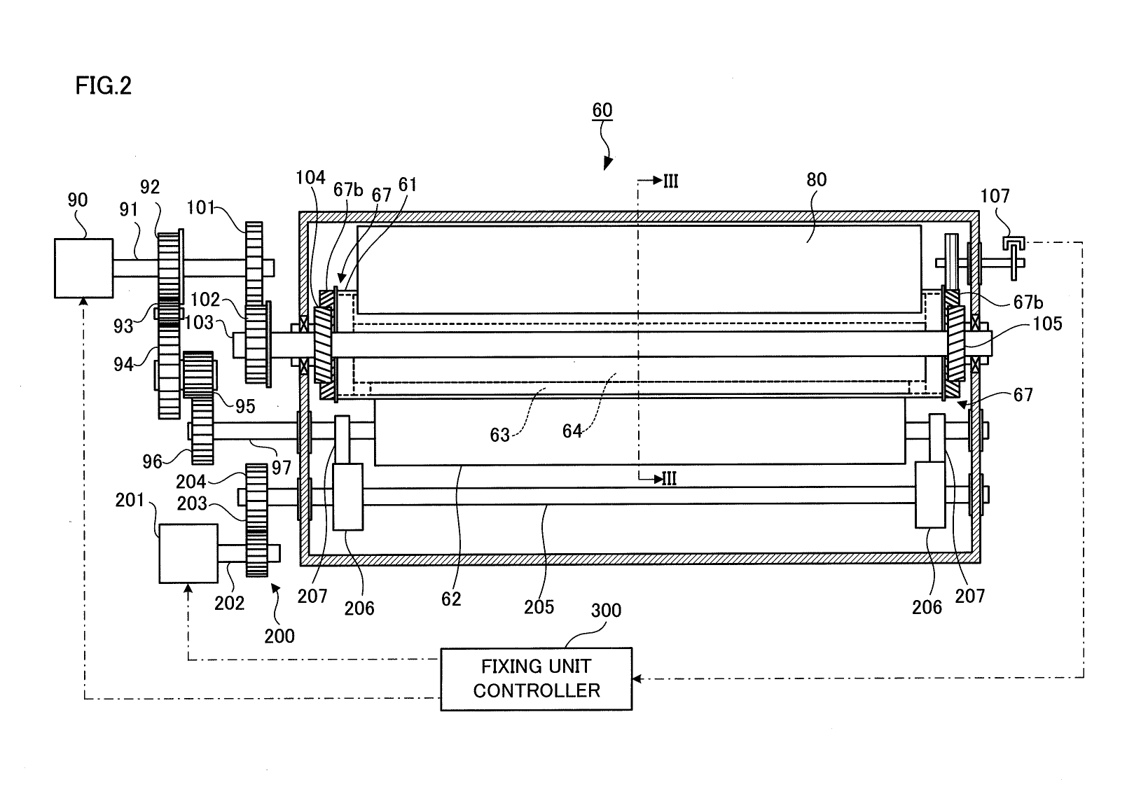

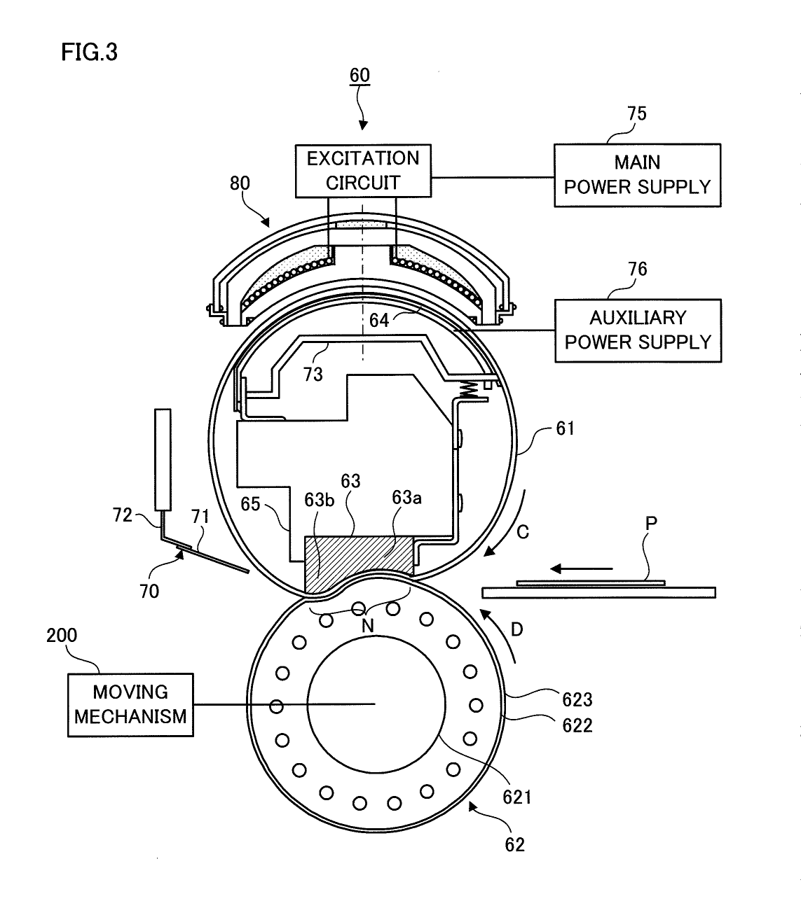

FIGS. 2 and 3 are diagrams showing a configuration of the fixing unit 60 of the present exemplary embodiment. FIG. 2 is a front view, and FIG. 3 is a cross-sectional view, taken along the line III-III in FIG. 2.

Firstly, as shown in FIG. 3, which is a cross-sectional view, the fixing unit 60 includes: an induction heating (IH) heater 80 as an example of a magnetic field generating member that generates an AC (alternate-current) magnetic field; a fixing belt 61 as an example of a fixing member that is subjected to electromagnetic induction heating by the IH heater 80, and thereby fixes a toner image on the sheet P; a pressure roll 62 as an example of a pressure member that is arranged in a manner to face the fixing belt 61; and a pressing pad 63 that is pressed by the pressure roll 62 with the fixing belt 61 therebetween. The pressure roll 62 comes into pressure contact with an outer peripheral surface of the fixing belt 61, thereby to form a nip portion N (fixing pressure portion) between the pressure roll 62 and the fixing belt 61, the nip portion N allowing the sheet P carrying an unfixed toner image to pass therethrough.

The fixing unit 60 further includes: a holder 65 that supports a constituent member such as the pressing pad 63; a heat storage member 64 that interposes the fixing belt 61 therebetween and is arranged so as to face the IH heater 80 while being arranged so as to be in contact with the fixing belt 61, the heat storage member 64 storing heat generated by the fixing belt 61; a magnetic path shielding member 73 that prevents the magnetic path from leaking toward the holder 65; and a peeling assisting member 70 that assists peeling of the sheet P from the fixing belt 61. Additionally, the fixing unit 60 is connected to: a main power supply 75, as an example of a first power supply, which supplies electric power to the IH heater 80; and an auxiliary power supply 76, as an example of a second power supply, which supplies electric power to the heat storage member 64.

### <Description of Fixing Belt>

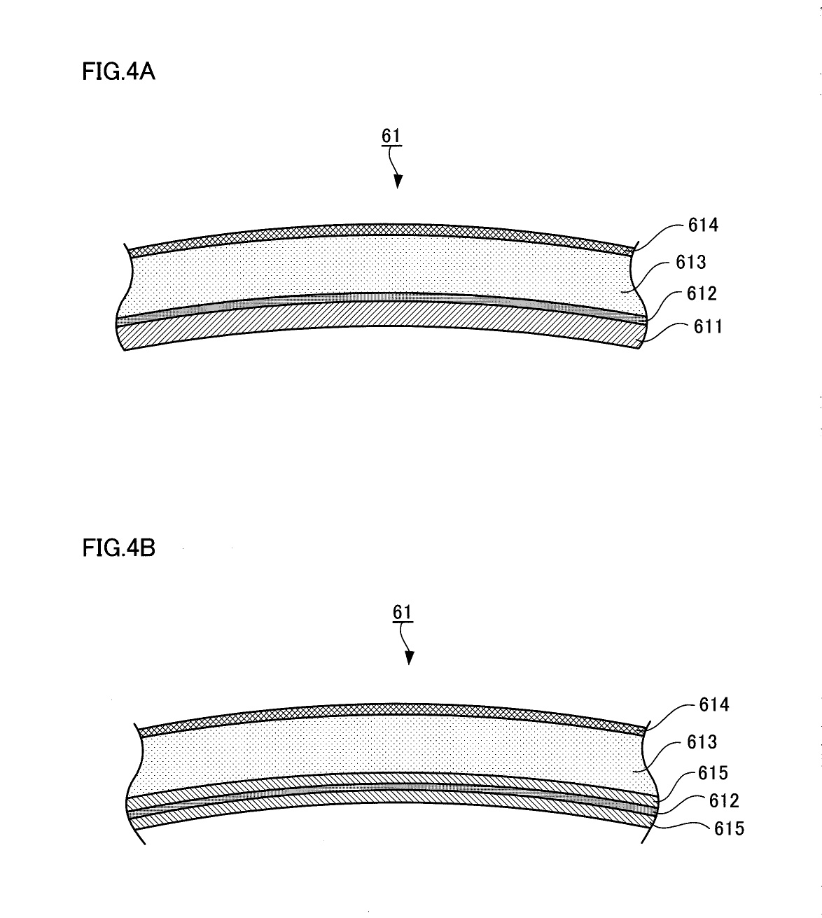

The fixing belt 61 is formed of an endless belt member originally formed into a cylindrical shape, and is formed with a diameter of 30 mm and a width-direction length of 370 mm in the original shape (cylindrical shape), for example. In addition, as shown in FIG. 4A (a configuration diagram showing cross-sectional layers of the fixing belt 61), the fixing belt 61 is a belt member having a multi-layer structure, for example, including: a base material layer 611; a conductive heat-generating layer 612 that is stacked on the base material layer 611; an elastic layer 613 that improves fixing properties of a toner image; and a surface release layer 614 that is applied as the uppermost layer.

The base material layer 611 is formed of a heat-resistant sheet-like member that supports the conductive heat-generating layer 612, which is a thin layer, and that gives a mechanical strength to the entire fixing belt 61. Moreover, the base material layer 611 is formed of a certain material with a certain thickness. The material has properties (relative permeability, specific resistance) that allow a magnetic field to pass therethrough so that the AC magnetic field generated at the IH heater 80 may act on the heat storage member 64. Meanwhile, the base material layer 611 itself is formed so as not to generate heat by action of the magnetic field or not to easily generate heat.

Specifically, for example, a non-magnetic metal such as a non-magnetic stainless steel having a thickness of 30 μm to 200 μm (preferably, 50 μm to 150 μm), or a resin material or the like such as polyimide having a thickness of 30 μm to 100 μm is used as the base material layer 611.

The conductive heat-generating layer 612 is an example of a conductive layer and is heated by electromagnetic induction with an intersecting AC magnetic field generated at the IH heater 80. Specifically, the conductive heat-generating layer 612 is a layer that generates an eddy current when the AC magnetic field from the IH heater 80 passes therethrough in the thickness direction.

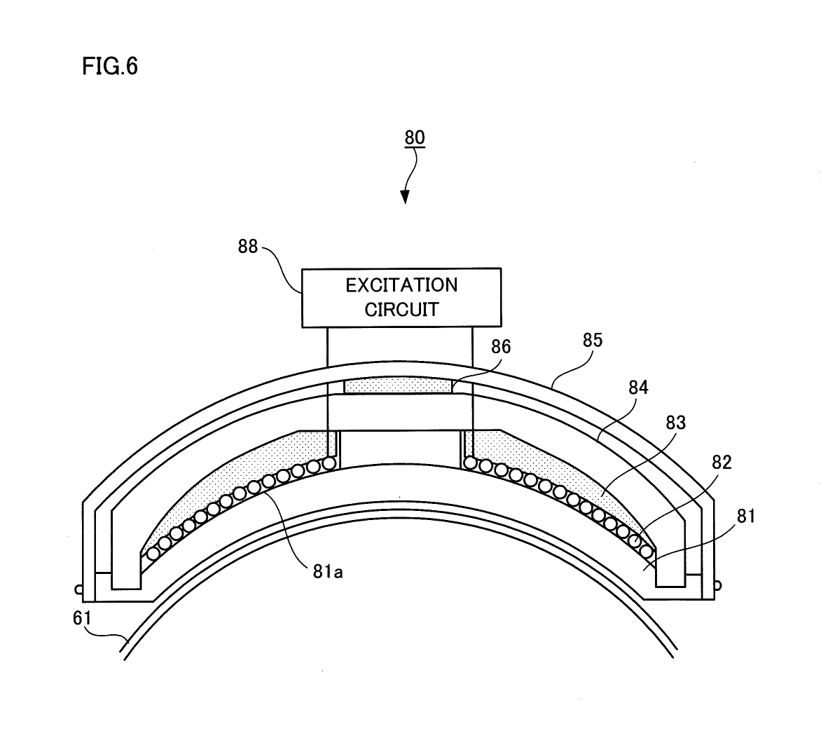

Normally, an inexpensively manufacturable general-purpose power supply is used as the main power supply 75 for an excitation circuit (also refer to later described FIG. 6) that supplies an AC current to the IH heater 80. For this reason, in general, the frequency of the AC magnetic field generated by the IH heater 80 ranges from 20 kHz to 100 kHz by use of the general-purpose power supply. Accordingly, the conductive heat-generating layer 612 is formed to allow the AC magnetic field having a frequency of 20 kHz to 100 kHz to enter and to pass therethrough.

A region of the conductive heat-generating layer 612, where the AC magnetic field is allowed to enter is defined as a “skin depth (δ)” representing a region where the AC magnetic field attenuates to 1/e. The skin depth (δ) is derived from the following formula (1), where f is the frequency of the AC magnetic field (20 kHz, for example), ρ is a specific resistance value (Ωm), and μr is a relative permeability.

Accordingly, in order to allow the AC magnetic field having a frequency of 20 kHz to 100 kHz to enter and then to pass through the conductive heat-generating layer 612, the thickness of the conductive heat-generating layer 612 is configured to be smaller than the skin depth (δ) of the conductive heat-generating layer 612, which is defined by the formula (1). In addition, as the material that forms the conductive heat-generating layer 612, a metal such as Au, Ag, Al, Cu, Zn, Sn, Pb, Bi, Be or Sb, or a metal alloy including at least one of these elements is used, for example.

$$δ = 503 \sqrt{\frac{ρ}{f \cdot {μ}_{r}}} \qquad ( 1 )$$

Specifically, as the conductive heat-generating layer 612, a non-magnetic metal (a non-magnetic material having a relative permeability substantially equal to 1) including Cu or the like, having a thickness of 2 to 20 μm and a specific resistance value not greater than 2.7×10⁻⁸ Ωm is used, for example.

In addition, in view of shortening the period of time required for heating the fixing belt 61 to reach a fixation setting temperature (hereinafter, referred to as a “warm-up time”) as well, the conductive heat-generating layer 612 may be formed into a thin layer. In the present exemplary embodiment, the conductive heat-generating layer 612 may be formed so as to have a thickness of 5 μm to 15 μm.

Next, the elastic layer 613 is formed of a heat-resistant elastic material such as a silicone rubber. The toner image to be held on the sheet P, which is to become the fixation target, is formed of a multi-layer of color toner as powder. For this reason, in order to uniformly supply heat to the entire toner image at the nip portion N, the surface of the fixing belt 61 may particularly be deformed so as to correspond with unevenness of the toner image on the sheet P. In this respect, a silicone rubber having a thickness of 100 to 600 μm and a hardness of 10° to 30° (JIS-A), for example, may be used for the elastic layer 613.

The surface release layer 614 directly contacts with an unfixed toner image held on the sheet P. Accordingly, a material with a high releasing property is used. For example, a PFA (a polymer of tetrafluoroethylene and perfluoroalkylvinylether) layer, a PTFE (polytetrafluoroethylene) layer or a silicone copolymer layer or a composite layer formed of these layers is used. As to the thickness of the surface release layer 614, if the thickness is too small, no sufficient wear resistance is obtained, hence, reducing the life of the fixing belt 61. On the other hand, if the thickness is too large, the heat capacity of the fixing belt 61 becomes so large that the warm-up time becomes longer. In this respect, the thickness of the surface release layer 614 may be particularly 1 to 50 μm in consideration of the balance between the wear resistance and heat capacity.

Note that the fixing belt 61 is not limited to those which have the configuration shown in FIG. 4A. For example, as shown in FIG. 4B, the fixing belt 61 may be one having a stainless layer 615, a conductive heat-generating layer 612, a stainless layer 615, an elastic layer 613 and a surface release layer 614 stacked in this order. The fixing belt 61 shown in FIG. 4B is a so-called metal clad belt, in which a metal clad layer composed of a pair of stainless layers 615 and a conductive heat-generating layer 612 formed therebetween is provided for the fixing belt 61 shown in FIG. 4A, instead of the base material layer 611. In this case, the conductive heat-generating layer 612 may be formed so as to have a thickness of 5 μm to 20 μm.

### <Description of Pressing Pad>

The pressing pad 63 is formed of an elastic material such as a silicone rubber or fluorine rubber, and is supported by the holder 65 at a position facing the pressure roll 62. Then, the pressing pad 63 is arranged in a state of being pressed by the pressure roll 62 with the fixing belt 61 therebetween, and forms the nip portion N (the fixing pressure portion) between the pressing pad 63 and the pressure roll 62.

In addition, the pressing pad 63 has two different nip pressures set for a pre-nip region 63a on the sheet entering side of the nip portion N (upstream side in the transport direction of the sheet P) and a peeling nip region 63b on the sheet exit side of the nip portion N (downstream side in the transport direction of the sheet P), respectively. Specifically, at the pre-nip region 63a, the surface thereof on the pressure roll 62 side is formed into a circular arc shape approximately corresponding with the outer peripheral surface of the pressure roll 62, and the nip portion N which is uniform and wide is formed. Meanwhile, the peeling nip region 63b is formed into a shape so as to be pressed with a locally large nip pressure from the surface of the pressure roll 62 in order that the curvature radius of the fixing belt 61 passing through the peeling nip region 63b may be small. Thereby, a curl (down curl) in a direction away from the surface of the fixing belt 61 is formed on the sheet P passing through the peeling nip region 63b, thereby promoting the peeling of the sheet P from the surface of the fixing belt 61.

Note that, in the present exemplary embodiment, the peeling assisting member 70 is arranged at the downstream side of the nip portion N as an assistance unit for the peeling by the pressing pad 63. In the peeling assisting member 70, a peeling baffle 71 is supported by a holder 72 in a state of being positioned close to the fixing belt 61 in a direction opposite to the rotational moving direction of the fixing belt 61 (so-called counter direction). Then, the peeling baffle 71 supports the curl portion formed on the sheet P at the exit of the pressing pad 63, thereby preventing the sheet P from moving toward the fixing belt 61.

### <Description of Holder>

The holder 65 that supports the pressing pad 63 is formed of a material having a high rigidity so that the amount of deflection in a state where the pressing pad 63 receives pressing force from the pressure roll 62 may be not greater than a certain amount. In this manner, pressure (nip pressure) at the nip portion N in the longitudinal direction is kept uniform. Moreover, since the fixing unit 60 of the present exemplary embodiment employs a configuration in which the fixing belt 61 is heated by use of electromagnetic induction, the holder 65 is formed of a material that provides no or little influence to an induction magnetic field, and that is not or hardly influenced by the induction magnetic field. For example, a heat-resistant resin such as glass mixed PPS (polyphenylene sulfide), or a non-magnetic metal material such as Al, Cu or Ag is used.

### <Description of Pressure Roll>

The pressure roll 62 is arranged to face the fixing belt 61 and rotates at, for example, a process speed of 140 mm/s in the direction of an arrow D in FIG. 3. The nip portion N is formed in a state where the fixing belt 61 is held between the pressure roll 62 and the pressing pad 63. Then, while the sheet P holding an unfixed toner image is caused to pass through this nip portion N, heat and pressure are applied to the sheet P, and thereby, the unfixed toner image is fixed onto the sheet P.

The pressure roll 62 is formed of a multi-layer including: a solid aluminum core (cylindrical core metal) 621 having a diameter of 18 mm, for example; a heat-resistant elastic layer 622 that covers the outer peripheral surface of the core 621, and that is made of silicone sponge or the like having a thickness of 5 mm, for example; and a release layer 623 that is a covering formed of a heat-resistant resin such as PFA containing carbon, or a heat-resistant rubber, having a thickness of 50 μm, for example. The pressing pad 63 is pressed under a load of 20 kgf, for example, with the fixing belt 61 therebetween.

As described above, the heat-resistant elastic layer 622 and the release layer 623 forming the surface of the pressure roll 62 are formed of relatively soft materials. For this reason, if the pressure roll 62 is left in a state where the pressure roll 62 is in pressure contact with the pressing pad 63 with the fixing belt 61 therebetween even when fixation is not performed, the pressure roll 62 may become unrecoverable to the original shape. That is, the pressure roll 62 deforms and remains in a shape formed by the nip portion N (the fixing pressure portion). In this case, pressure applied to the nip portion N becomes different from the originally designed pressure. Thus, the fixation is not performed in accordance with the specification, which results in loss of performance of the fixing unit 60.

Accordingly, a moving mechanism 200 is provided to the pressure roll 62, and an operation to separate the pressure roll 62 from the fixing belt 61 is performed during a period other than when fixation is performed. That is, when fixation is performed, the pressure roll 62 is brought into pressure contact with an outer peripheral surface of the fixing belt 61 and forms the nip portion N for inserting a sheet P holding an unfixed toner image thereon between the pressure roll 62 and the fixing belt 61. When fixation is not performed, the pressure roll 62 moves so as to separate from the fixing belt 61. That is, in the present exemplary embodiment, the moving mechanism 200 moves the pressure roll 62, allowing the pressure roll 62 to change between a state where the pressure roll 62 is brought into pressure contact with the outer peripheral surface of the fixing belt 61 and a state where the pressure roll 62 is separated therefrom.

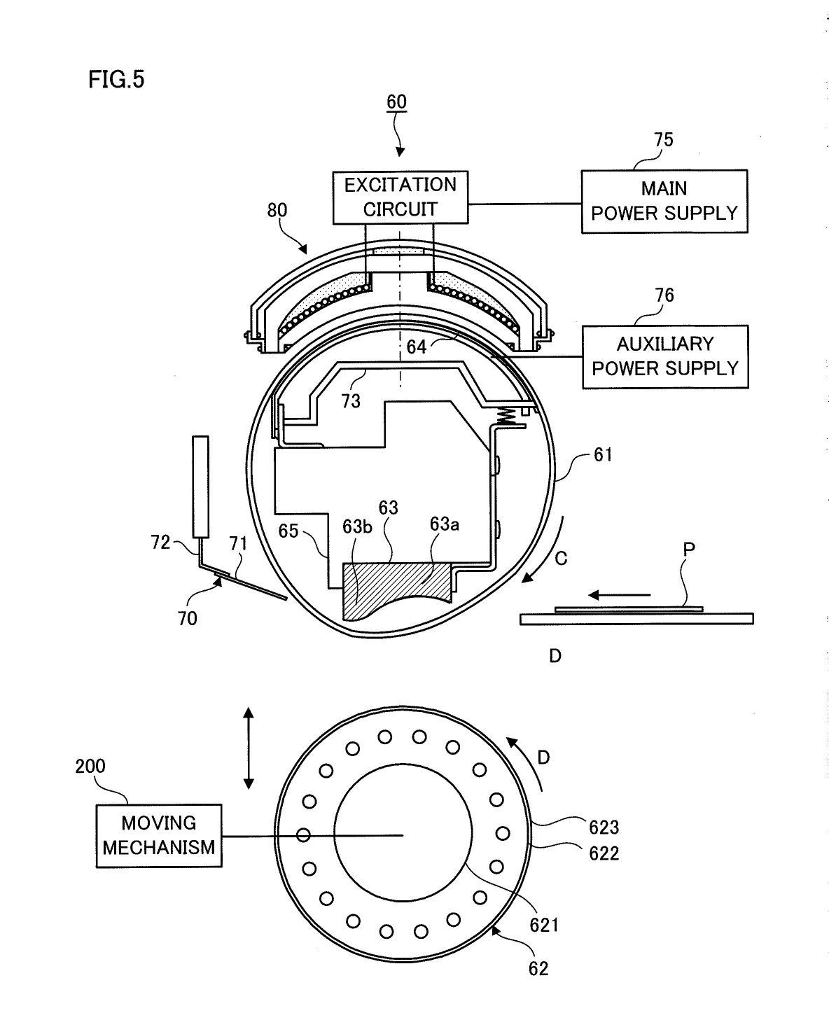

FIG. 5 is a diagram illustrating the state in which the pressure roll 62 is separated from the fixing belt 61 by the moving mechanism 200.

As shown in FIG. 5, the pressure roll 62 and the fixing belt 61 are in the state of being separated from each other. As a result, the shape of the pressure roll 62 recovers to the original circular shape, so that the pressure roll 62 is less likely to deform and to become unrecoverable to the original shape.

Note that, when fixation is performed, the pressure roll 62 may be brought into contact with the fixing belt 61 again by the moving mechanism 200, and return to the position to form the nip portion N as described in FIG. 3.

### <Description of Drive Mechanism of Pressure Roll and Fixing Belt>

Next, by use of FIGS. 2, 3 and 5, a description will be given of a drive mechanism of the pressure roll 62 and the fixing belt 61 in the fixing unit 60 according to the present exemplary embodiment.

Here, suppose that the fixing unit 60 is first set in the separated state prior to the fixing operation, as shown in FIG. 5. During standby prior to the fixing operation, the pressure roll 62 is placed by the moving mechanism 200 at a warm-up position that is away from the fixing belt 61. The warm-up position is an arrangement position of the pressure roll 62 at the time of warm-up. At the warm-up position, the pressure roll 62 is in a so-called latch-off state where the pressure roll 62 does not come into physical contact with the fixing belt 61.

As shown in FIG. 2, in the fixing unit 60, rotational drive force from a drive motor 90 as an example of a drive unit is transmitted to a shaft 97 via a transmission gear 92 fixed to a rotation axis 91 and transmission gears 93, 94, 95 and 96. Thereby, the rotational drive force is transmitted to the pressure roll 62, and the pressure roll 62 is driven to rotate in the direction of the arrow D.

Next, the rotational drive force from the drive motor 90 is transmitted to a shaft 103 via a transmission gear 101 fixed to the rotation axis 91 coaxially with the transmission gear 92 and an one-way clutch 102 as an example of a rotational transmission restricting member. The rotational drive force is then transmitted from transmission gears 104 and 105 connected to the shaft 103 to gears 67b of end cap members 67 arranged on both sides of the fixing belt 61. Thereby, the rotational drive force is transmitted from the end cap members 67 to the fixing belt 61, and the end cap members 67 and the fixing belt 61 are integrally driven to rotate. At this time, the fixing belt 61 directly receives the drive force at both of the ends of the fixing belt 61 and rotates in the direction of an arrow C.

Next, at the time of the fixing operation as shown in FIG. 3, the fixing unit 60 is in a so-called latch-on state where the pressure roll 62 is in pressure contact with the fixing belt 61 by the moving mechanism 200. The reduction ratio of a gear train is set so that the surface speed of the fixing belt 61 is smaller than that of the pressure roll 62 in the latch-off state. For this reason, in the latch-on state, the one-way clutch 102 operates so that the fixing belt 61 rotates in accordance with the pressure roll 62, which stops the transmission of the rotational drive force from the drive motor 90 to the shaft 103. That is, in the state of FIG. 3, the rotational drive force is transmitted to the pressure roll 62, but not to the fixing belt 61. Thus, the pressure roll 62 is driven in the direction of the arrow D by receiving the rotational drive force from the drive motor 90, while the fixing belt 61 rotates in the direction of the arrow C in accordance with the rotation of the pressure roll 62. That is, in this state, the drive motor 90 rotates the pressure roll 62, thereby to rotate the fixing belt 61.

The fixing unit 60 of the present exemplary embodiment includes a revolution sensor 107, which is an example of a revolution number sensing unit, and senses the number of revolutions of the fixing belt 61. The number of revolutions of the fixing belt 61 sensed by the revolution sensor 107 is outputted to a fixing unit controller 300. The fixing unit controller 300 controls the drive motor 90. That is, the drive motor 90 is subjected to a feedback control on the basis of the number of revolutions of the fixing belt 61 sensed by the revolution sensor 107. The fixing unit controller 300 further controls the moving mechanism 200, and causes the moving mechanism 200 to move the pressure roll 62, thereby to change the states of the pressure roll 62 and the fixing belt 61 between pressure contact and separation.

The moving mechanism 200 includes: a latch motor 201 as a drive source for positioning; a rotation axis 202 connected to the latch motor 201; transmission gears 203 and 204; a shaft 205 connected to the transmission gear 204; eccentric cams 206 rotated by the shaft 205; and levers 207 connected to the shaft 97 of the pressure roll 62 and moved by the eccentric cams 206. Rotation of the eccentric cams 206 presses the levers 207, and thereby moves the pressure roll 62 in the up-and-down directions in FIG. 2. Thereby, the pressure roll 62 operates to come into pressure contact with the fixing belt 61 and separate therefrom.

### <Description of IH Heater>

Next, a description will be given of the IH heater 80 that heats the fixing belt 61 by electromagnetic induction with an action of an AC magnetic field in the conductive heat-generating layer 612 of the fixing belt 61.

FIG. 6 is a cross-sectional view illustrating a configuration of the IH heater 80 of the present exemplary embodiment. As shown in FIG. 6, the IH heater 80 includes: a support 81 formed of a non-magnetic material such as a heat-resistant resin, for example; and an excitation coil 82 that generates an AC magnetic field. The IH heater 80 also includes: elastic support members 83 each formed of an elastic material that fixes the excitation coil 82 onto the support 81; and a magnetic core 84 that forms a magnetic path of the AC magnetic field generated at the excitation coil 82. The IH heater 80 further includes: a shield 85 that shields the magnetic field; a pressure member 86 that presses the magnetic core 84 toward the support 81; and an excitation circuit 88 that supplies an AC current to the excitation coil 82.

The support 81 is formed into a shape in which the cross section thereof is curved along the shape of the surface of the fixing belt 61, and is formed so as to keep a predetermined gap (0.5 to 2 mm, for example) between an upper surface (supporting surface) 81a that supports the excitation coil 82 and the surface of the fixing belt 61. Examples of the material that forms the support 81 include a heat-resistant non-magnetic material such as: a heat-resistant glass; a heat-resistant resin including polycarbonate, polyethersulphone or PPS (polyphenylene sulfide); and a heat-resistant resin containing a glass fiber therein.

The excitation coil 82 is formed by winding a litz wire in a closed loop of an oval shape, elliptical shape or rectangular shape having an opening inside, the litz wire being obtained by bundling ninety pieces of mutually isolated copper wires each having a diameter of 0.17 mm, for example. When an AC current having a predetermined frequency is supplied from the excitation circuit 88 to the excitation coil 82, an AC magnetic field on the litz wire wound in a closed loop shape as the center is generated around the excitation coil 82. In general, a frequency of 20 kHz to 100 kHz, which is generated by the aforementioned general-purpose power supply, is used for the frequency of the AC current supplied from the excitation circuit 88 to the excitation coil 82.

For the magnetic core 84, a ferromagnetic material, formed of an oxide or alloy material with a high permeability, such as a soft ferrite, a ferrite resin, a non-crystalline alloy (amorphous alloy), permalloy or a temperature-sensitive magnetic alloy is used. The magnetic core 84 functions as a magnetic path forming unit. The magnetic core 84 induces, to the inside thereof, the magnetic field lines (magnetic flux) of the AC magnetic field generated at the excitation coil 82, and forms a path (magnetic path) of the magnetic field lines in which the magnetic field lines from the magnetic core 84 run across the fixing belt 61 to be directed to the heat storage member 64, then pass through the inside of the heat storage member 64, and return to the magnetic core 84. Specifically, a configuration in which the AC magnetic field generated at the excitation coil 82 passes through the inside of the magnetic core 84 and the inside of the heat storage member 64 is employed, and thereby, a closed magnetic path where the magnetic field lines internally wrap the fixing belt 61 and the excitation coil 82 is formed. Thereby, the magnetic field lines of the AC magnetic field generated at the excitation coil 82 are concentrated at a region of the fixing belt 61, which faces the magnetic core 84.

The material of the magnetic core 84 may be one that has a small amount of loss due to the formation of the magnetic path. Specifically, the magnetic core 84 may be particularly used in a form that reduces the amount of eddy-current loss (shielding or dividing of the electric current path due to a slit or the like, or bundling of thin plates, or the like). The magnetic core 84 may be particularly formed of a material having a small hysteresis loss.

The length of the magnetic core 84 in the rotation direction of the fixing belt 61 is determined so as to be shorter than that of the heat storage member 64 in the rotation direction of the fixing belt 61. Thereby, the amount of leakage of the magnetic field lines toward the periphery of the IH heater 80 is reduced, resulting in improvement in the power factor. Moreover, the electromagnetic induction toward the metal materials forming the fixing unit 60 is also suppressed and the heat-generating efficiency at the fixing belt 61 (conductive heat-generating layer 612) increases.

### <Description of Heat Storage Member>

The heat storage member 64 stores heat generated in the fixing belt 61 through electromagnetic induction heating caused by the IH heater 80. Since performing fixation decreases the temperature of the fixing belt 61, because heat is taken away therefrom. However, heat generated by the heat storage member 64, together with heat generated from the fixing belt 61 through electromagnetic induction heating, allows for reheating. This allows for reducing a temperature change of the fixing belt 61 and making the temperature of the fixing belt 61 more uniform. Thus, provision of the heat storage member 64 makes the fixing operation of the fixing unit 60 more stable.

However, for example, at the time of a startup of the fixing unit 60 or the like, a time (a warm-up time) required increasing the temperature of the fixing belt 61 up to a fixable temperature may be longer. That is, since the heat storage member 64 is cooled down at startup of the fixing unit 60, heat generated in the fixing belt 61 is taken away from the heat storage member 64, which makes the temperature of the fixing belt 61 difficult to rise.

To address the problem described above, the heat storage member 64 has the following configuration in the present exemplary embodiment.

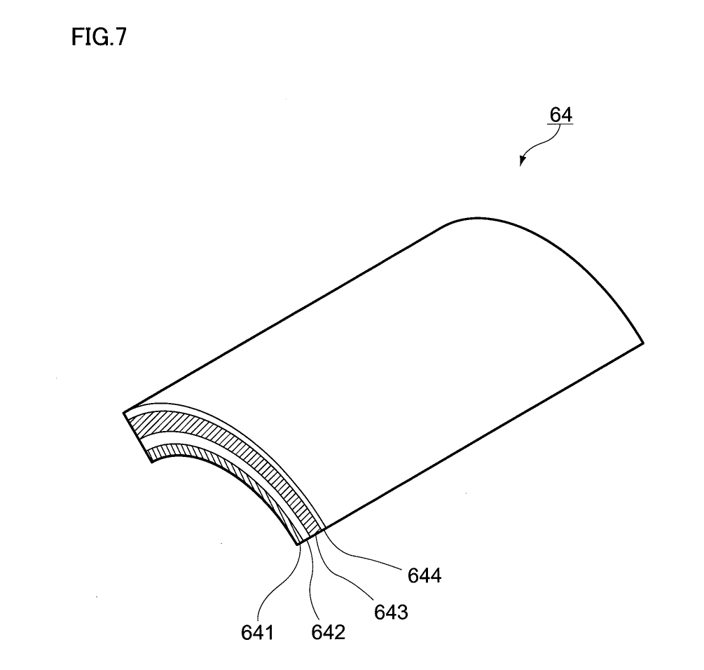

FIG. 7 is a perspective view illustrating a configuration of the heat storage member 64 of the present exemplary embodiment.

As shown in FIG. 7 the heat storage member 64 includes: a resistive heating layer 641 having a resistive heater; an insulating layer 642 being a base of the resistive heater; an electromagnetic induction heating layer 643 that is provided so as to face the resistive heating layer 641 with the insulating layer 642 interposed therebetween; and a sliding layer 644 that comes into contact with the fixing belt 61.

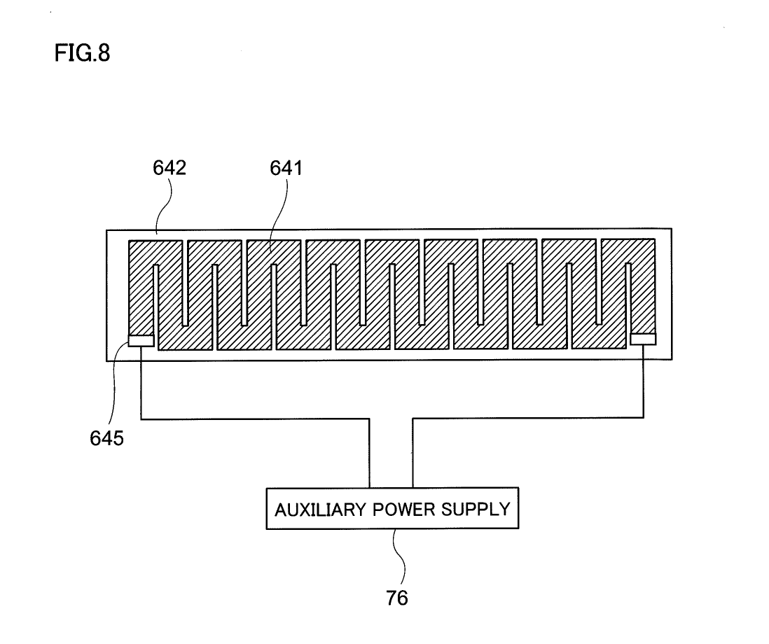

FIG. 8 is a diagram illustrating the resistive heating layer 641 and the insulating layer 642 in more detail.

In the present exemplary embodiment, the resistive heating layer 641 is arranged on the sheet-like insulating layer 642. The resistive heating layer 641 is formed of a resistive heater generating Joule heat by being supplied with electric power. Additionally, in the present exemplary embodiment, the resistive heating layer 641 is arranged in a zigzag pattern. The zigzag pattern of the resistive heating layer 641 allows for heating the heat storage member 64 more uniformly. That is, nonuniformity in temperature of the heat storage member 64 is reduced. Further, a pair of electrodes 645 is arranged at both ends of the resistive heating layer 641, and is connected with the auxiliary power supply 76. Supply of electric power from the auxiliary power supply 76 to the resistive heating layer 641 via the electrodes 645 causes the resistive heating layer 641 to generate Joule heat.

The resistive heating layer 641 may be formed as a metal thin layer formed on the insulating layer 642. For example, the resistive heating layer 641 may be formed by plating the insulating layer 642 with copper in the pattern as shown in FIG. 8. In this case, the resistive heater is copper. In the present exemplary embodiment, the thickness of the copper plating forming the resistive heating layer 641 is determined according to a voltage applied by the auxiliary power supply 76 and a required heating value. For example, if the voltage applied by the auxiliary power supply 76 is from 12 V to 100 V and the required heating value is from 500 W to 1000 W, the thickness of the copper plating is from 1 μm to 10 μm. In the present exemplary embodiment, for example, the copper plating is formed to have a thickness of 2 μm and, is formed into a band having a width of 13 mm and making twenty turns in a zigzag manner. Thereby, the resistive heating layer 641 is made in which, for example, the length in the long-side direction is 310 mm and the length in the short-side direction is 50 mm. In this case, the resistance value of the resistive heating layer 641 is about 0.65Ω. Application of a direct-current voltage of 18 V provides a heating value of about 500 W.

In addition, stainless foil, for example, may be used for the resistive heating layer 641. In this case, the resistive heater is stainless. In this case, by attaching the stainless foil onto the insulating layer 642, the resistive heating layer 641 is formed on the insulating layer 642. Then, the stainless foil is formed to have a thickness of 15 μm and, is formed into a band having a width of 35 mm and making seven turns in a zigzag manner. Thereby, the resistive heating layer 641 is made in which, for example, the length in the long-side direction is 310 mm and the length in the short-side direction is 50 mm. Then, the resistance value of the resistive heating layer 641 is about 1Ω. Application of a direct-current voltage of 2 V provides a heating value of about 500 W.

Additionally, the resistive heating layer 641 may be formed by using a conductive resin film. A case in which a resin film having conductive filler dispersed therein is used as the resistive heater is taken as an example. Specifically, Kapton 200RS100 or the like manufactured by DuPont Kabushiki Kaisha may be used. By attaching the film having a thickness of 25 μm onto the insulating layer 642, the resistive heating layer 641 may be formed on the insulating layer 642.

The insulating layer 642 is an insulating resin film made of polyimide or the like, for example. The insulating layer 642 is arranged between the resistive heating layer 641 and the electromagnetic induction heating layer 643, thereby providing electrical insulation between the resistive heating layer 641 and the electromagnetic induction heating layer 643. The insulating layer 642 may have a thickness of 25 μm, for example.

The electromagnetic induction heating layer 643 generates heat due to occurrence of electromagnetic induction caused by an AC magnetic field generated by the IH heater 80. By providing the electromagnetic induction heating layer 643, the magnetic field lines of the AC magnetic field generated by the IH heater 80 is induced to the inside of the heat storage member 64 after penetrating the fixing belt 61. Thus, the magnetic field lines running across the conductive heat-generating layer 612 of the fixing belt 61 in the thickness direction concentrate so as to enter the inside of the heat storage member 64, which increases the magnetic flux density more.

In the present exemplary embodiment, the electromagnetic induction heating layer 643 may be formed by use of a temperature-sensitive magnetic material. A temperature-sensitive magnetic material has a property (“temperature-sensitive magnetic property”) that reversibly changes between ferromagnetism and non-magnetism (paramagnetism). That is, a temperature-sensitive magnetic material is a ferromagnetic material at a temperature below the Curie point, but is turned into a non-magnetic material at a temperature above the Curie point.

Temperature-sensitive magnetic materials are roughly classified into metal materials and oxide materials. An oxide material (for example, a soft ferrite and the like) is difficult to thin, and is fragile and unhandy. Additionally, an oxide material has a high heat capacity and a low heat conductivity, and thus is likely to cause a problem, such as lack of sensitive response and difficulty in controlling heat generation at the time of occurrence of a rapid temperature change in the fixing belt 61.

Accordingly, a metal material may be particularly used that has characteristics of being unlikely to cause the above problem, being inexpensive and readily formable into a thin shape, and having favorable formability, flexibility and a high heat conductivity. Among others, a magnetic shunt alloy or an amorphous alloy may be particularly used. More specifically, a metal alloy material consisting of Fe, Ni, Cr, Si, B, Nb, Cu, Zr, Co, V, Mn, Mo or the like may be used. Among others, an Fe—Ni binary magnetic shunt alloy or an Fe—Ni—Cr ternary magnetic shunt alloy may be used.

Forming the electromagnetic induction heating layer 643 with a temperature-sensitive magnetic material may lead to prevention of a temperature increase at an non-sheet passing portion of the fixing belt 61 when small-sized sheets successively pass through the fixing unit 60 (see FIG. 3). That is, in the fixing belt 61, a sheet passing portion has heat taken away by the sheet P, while the non-sheet passing portion does not have heat taken away by the sheet P and is likely to have a temperature increase. Since a temperature-sensitive magnetic material has a characteristic of being a non-magnetic material above the Curie point, heat generation through electromagnetic induction stops when the electromagnetic induction heating layer 643 reaches the Curie temperature. Thus, the electromagnetic induction heating layer 643 is unlikely to have a temperature increase at a temperature above the Curie point. As a result, supply of heat to the fixing belt 61 is decreased, thereby preventing a temperature increase at the non-sheet passing portion of the fixing belt 61. In the present exemplary embodiment, the Curie point of a temperature-sensitive magnetic material may be more than the ordinary fixing operation temperature and less than the upper temperature limit of the fixing belt 61. More specifically, the Curie point may be particularly set between 190 degrees C. to 230 degrees C.

The sliding layer 644 is a layer to reduce sliding resistance between the heat storage member 64 and the fixing belt 61. Provision of the sliding layer 644 may reduce resistance at the time of rotation of the fixing belt 61, and reduce abrasion on the inner surface side of the fixing belt 61.

The sliding layer 644 may be formed by coating the electromagnetic induction heating layer 643 with chromium nitride (CrN, CrN₂), Tetrahedral Amorphous Carbon (ta-C), Diamond Like Carbon (DLC), or the like, for example.

The above configuration of the heat storage member 64 may give the heat storage member 64 not only a function of storing heat but also a function of generating heat. Since the heat storage member 64 may generate heat thereby to supply heat to the fixing belt 61, supply of electric power to the heat storage member 64 to generate heat especially prior to starting fixation may reduce the warm-up time of the fixing unit 60.

### <Description of Power Supply>

In the present exemplary embodiment, the main power supply 75 is connected to the IH heater 80, and the auxiliary power supply 76 is connected to the resistive heating layer 641 of the heat storage member 64. The main power supply 75 supplies electric power to the IH heater 80 almost all the time from turn-on of the fixing unit 60 to the end of the fixing operation. On the other hand, in the present exemplary embodiment, the auxiliary power supply 76 supplies electric power to the resistive heating layer 641 before the start of the fixation and after the turn-on of the fixing unit 60. For this reason, both of the main power supply 75 and the auxiliary power supply 76 may be used to supply electric power in this period. Thus, supply of electric power from the main power supply 75 to the IH heater 80 allows the conductive heat-generating layer 612 of the fixing belt 61 to generate heat, causing the fixing belt 61 itself to generate heat, while supply of electric power from the auxiliary power supply 76 to the resistive heating layer 641 allows for further heat supply from the inner surface side of the fixing belt 61. Thus, the warm-up time of the fixing unit 60 may be more reduced. Furthermore, in the present exemplary embodiment, since the heat storage member 64 is provided with the electromagnetic induction heating layer 643, this layer also supplies heat to the fixing belt 61. Thus, the warm-up time of the fixing unit 60 may be further reduced. This reduces the necessity to preheat the fixing belt 61 during standby of the fixing unit 60, and may lead to saving of electric power. Additionally, since provision of the electromagnetic induction heating layer 643 may supply more heat to the fixing belt 61, occurrence of a phenomenon (so-called “temperature droop phenomenon”) in which the fixing temperature drops is reduced even in high-speed fixing operations (for example, when sheets pass at 80 ppm (paper per minute)). If the heat storage member 64 of the present exemplary embodiment is not provided, the warm-up time is 30 s, for example. However, if the heat storage member 64 of the present exemplary embodiment is provided, the warm-up time becomes 10 s, for example.

As described above, in the present exemplary embodiment, since the auxiliary power supply 76 operates before the start of the fixing operation and after the turn-on of the fixing unit 60 and is provided for reducing the warm-up time, the auxiliary power supply 76 has relatively short uptime but is required to be capable of supplying relatively large electric power. To satisfy this property, the auxiliary power supply 76 may be one storing electric power and supplying electric power to the heat storage member 64 by electrically discharging. Specifically, the auxiliary power supply 76 may be a secondary battery or an electric double layer capacitor. In particular, an electric double layer capacitor has properties of having a long cycle lifetime, allowing for rapid charging and discharging, allowing for efficient charging and discharging, and the like. Thus, it satisfies the above-mentioned property required for the auxiliary power supply 76, and may be particularly used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a toner image forming unit that forms a toner image;
a transfer unit that transfers the toner image onto a recording medium;
a fixing unit comprising:
a fixing member having a conductive layer, the fixing member fixing toner onto a recording medium with the conductive layer heated by electromagnetic induction;
a pressure member that comes into pressure contact with an outer peripheral surface of the fixing member, thereby to form a fixing pressure portion between the pressure member and the fixing member, the fixing pressure portion allowing a recording medium carrying an unfixed image to pass therethrough;
a magnetic field generating member that generates an alternate-current magnetic field intersecting with the conductive layer of the fixing member; and
a heat storage member that is arranged so as to face the magnetic field generating member with the fixing member interposed therebetween while being arranged so as to be in contact with the fixing member, the heat storage member generating heat to supply heat to the fixing member;
a first power supply that supplies electric power to the magnetic field generating member of the fixing unit; and
a second power supply storing electric power, the second power supply electrically discharging to supply electric power to the heat storage member of the fixing unit.

2. The image forming apparatus according to claim 1, wherein the heat storage member of the fixing unit comprises a resistive heating layer having a resistive heater.

3. The image forming apparatus according to claim 2, wherein the heat storage member of the fixing unit further comprises an insulating layer and an electromagnetic induction heating layer provided so as to face the resistive heating layer with the insulating layer interposed therebetween.

4. The image forming apparatus according to claim 1, wherein the second power supply supplies electric power to the heat storage member before fixation is started.

5. The image forming apparatus according to claim 2, wherein the second power supply supplies electric power to the heat storage member before fixation is started.

6. The image forming apparatus according to claim 3, wherein the second power supply supplies electric power to the heat storage member before fixation is started.

7. A fixing device comprising:
a fixing member having a conductive layer, the fixing member fixing toner onto a recording medium with the conductive layer heated by electromagnetic induction;
a pressure member that comes into pressure contact with an outer peripheral surface of the fixing member, thereby to form a fixing pressure portion between the pressure member and the fixing member, the fixing pressure portion allowing a recording medium carrying an unfixed image to pass therethrough;
a magnetic field generating member that generates an alternate-current magnetic field intersecting with the conductive layer of the fixing member; and
a heat storage member that is arranged so as to face the magnetic field generating member with the fixing member interposed therebetween while being arranged so as to be in contact with the fixing member, the heat storage member generating heat to supply heat to the fixing member, wherein
the heat storage member comprises:
a resistive heating layer having a resistive heater;
an electromagnetic induction heating layer generating heat through electromagnetic induction with the alternate-current magnetic field generated by the magnetic field generating member; and
an insulating layer insulating the resistive heating layer and the electromagnetic induction heating layer.

8. The fixing device according to claim 7, wherein the resistive heating layer of the heat storage member is made of a metal thin layer formed on the insulating layer.
